(19) United States
(12) Patent Application Publication
(10) Pub. No.: US 2014/0026571 A1
(43) Pub. Date: Jan. 30, 2014

(54) HERMETICALLY SEALED SOLAR WATER HEATER SYSTEM AND OPERATION METHOD FOR GENERATION OF ELECTRICITY FROM THERMAL POWER PLANT

(71) Applicant: Raghunathan Rajagopal Valagam, Chennai (IN)

(72) Inventor: Raghunathan Rajagopal Valagam, Chennai (IN)

(21) Appl. No.: 14/005,234

(22) PCT Filed: Mar. 13, 2012
(86) PCT No.: PCT/IN2012/000171

§ 371 Date: Sep. 13, 2013

(30) Foreign Application Priority Data
Mar. 14, 2011 (IN) 766/CHE/2011

(51) Int. Cl. F03G 6/00; F22D 1/00

(52) U.S. Cl. CPC F03G 6/00; F22D 1/003
USPC 60/641.8; 122/412; 126/714

(57) ABSTRACT

The present invention discloses a hermitically sealed solar water heater system and operation method for generation of electricity from thermal power plant. Water storage tank (1) is hermitically sealed by diaphragm (13) to prevent feed water contamination. Solar energy based water heater (2) preheats feed water and raises water temperature close to the boiling point. The feed water heater by trapping the waste heat from the exhaust gases further heats the feed water and is pumped to the boiler and where it is converted to steam. The steam impinging on the turbine blades drives it and generates power from the generator. The steam condenses in the condenser and the water coming out of condenser is pumped to the overhead water tank and the process of power generation is continues uninterruptedly.

### FIELD OF THE INVENTION

This invention relates to the hermitically sealed solar water heater system and operation method for generation of electricity from thermal power plant. Power is generated from the turbine by combusting fossil fuel such as coal which emits harmful carbon emissions hazardous to the environment. To have a sustainable development for the future generation, the carbon emissions have to be controlled to prevent adverse effect on the ecosystem. The hermitically sealed solar water heater enables increasing the temperature of feed water before being fed to the boiler of the thermal unit. This preheating of the feed water reduces the consumption of coal which is supplied as fuel to the boiler, which increases the efficiency of thermal power plant and thereby reduces the consumption of coal due to which the emission of toxic substances is brought under control.

### BACKGROUND AND PRIOR ART OF THE INVENTION

Electricity Production continues to grow around the world, from a variety of sources. Global electricity production increases by 2.4 percent per year over the projection period. Total electricity demand in the developing nations is expected to grow from 2004 to 2030 at an annual rate that is nearly triple the rate of growth for electricity demand. The difference reflects the relative maturity of electricity infrastructure, as well as the expectation that populations in these countries generally will grow slowly or decline over the next 25 years. In addition, fast-paced growth in the developing economies translates to rising standards of living and robust growth in consumer demand for lighting and appliances. Among the energy end-use sectors, the most rapid growth in total world demand for electricity is projected for the buildings (residential and commercial) sectors.

The electricity about 70% is generated using fossil fuels, especially coal. There are several thousand power generating and supply organizations including investor owned utilities, government—especially municipal—utilities, rural electric cooperatives and independent power producers. Utilities and cooperatives sell the electricity to consumers, so do power marketers in some states, where consumers can now choose their supplier. The electric power industry is changing in a big way, called deregulation. Competition is being added at many levels. The future, including the role of fossil fuel, is hard to predict.

After food, fossil fuel is humanity's most important source of energy. There are three major fuels—coal, oil and natural gas. Coal is used primarily to produce electricity. It therefore provides us with light, motive power from electric motors, and our many electronic devices. Also these energy sources are at their depleting stage which raises concerns for the need to conserve them for the future generation. The combustion of fossil fuels emits harmful hydrocarbons which is causing a severe impact on the environment like global warming which also the need to keep an eye on their consumption besides the need to conserve them.

By harnessing renewable energy resources along with the fossil fuels, the effect the fossil fuel impart on the environment can be significantly reduced and also it can be conserved. The use of sunlight is an obvious way to reduce dependency on energy sources such as gas, oil, coal etc. The solar heating of water is particularly attractive because energy available at one time may be stored for use at a later time. Because energy storage is so convenient both with the diurnal cycle of the sun and with the intermittent reduction in the availability of sunlight due to the clouds.

Another advantage inherent in the use of sunlight to heat water involves the fact that the water need not be heated to high temperatures. Typically, the operating temperature range for a residential or commercial water heating system is between about 130 and about 150 F. Such a temperature range results in relatively high efficiency, and for this reason solar powered water heating systems do not require the use of highly sophisticated thermal collectors.

Solar thermal power plants have an advantage over those with a closed steam circuit, in that they require no cooling devices and are generally easier to regulate. They are therefore particularly suitable for use in calm regions with little water and high solar radiation for example in tropical regions.

A few patents are typical of the known prior art attempting to overcome the drawbacks involved in generation of hot water or steam by utilizing solar energy for commercial purpose. For example, U.S. Pat. No. 4,3145,45 to Bowman proposes a system which is related to a solar water heater generator system that will produce more hot water efficiently for domestic and commercial use than any in existence today. A device comprising of a plate glass top or a clear plastic top, a hot water generator core with two tanks contained in the device and a mirror reflecting bottom. A water gravity direction system that is controlled from the thermos tank to the generator core by an innovating valve system and a hot water hook up from the thermos tank to a domestic or commercial use. A solar thermo cline condition created by the solar hot water generator system that would be used in producing electricity.

While U.S. Pat. No. 0,260,359 to Palkes relates to a solar thermal power plant includes a steam generating portion having a seam drum and an evaporator. The steam drum separates water and steam. The evaporator receives the water from the steam drum to generate steam using solar energy provided thereto. The solar thermal power plant further includes a turbine that receives the steam from the steam generation portion. A plurality of extraction stages extracts steam from the turbine. A plurality of feed water heaters receive steam from the steam extraction stages to heat feed water provided by the turbine, wherein the heated feed water is provided to the steam generation portion.

But none of the prior art documents disclose an invention which is capable of producing hot water by utilizing solar energy by means of simple and cost effective method.

### SUMMARY OF THE INVENTION

According to the present aspect of invention, there is provided a hermitically sealed solar water heater system and operation method for generation of electricity from thermal power plant. It is achieved by providing the demineralised feed water preheated by utilizing solar energy to the boiler of the thermal power plant. The preheated feed water increases the efficiency of thermal power plant and reduces the consumption of fossil fuel and its toxic emissions. The feed water from the overhead water tank is prevented from being contaminated by diaphragm and it reaches solar water heater by potential drop. The hermitically sealed solar water heater receives water from the over head tank and it increases the temperature of feed water from its ambient temperature close to the boiling point of water which is then fed to the boiler of thermal power plant Since the boiler receives solar heated feed water, it uses less coal and reduces the toxic effect on the ecosystem than traditional systems.

### OBJECT OF THE INVENTION

It is an object of the invention to prevent the contamination of feed water by hermitically sealing the storage tank by means of diaphragm.

It is an object of the invention to increase the efficiency of thermal power plant by providing demineralised feed water preheated by solar energy.

It is an object of invention to utilize the renewable (solar) energy to preheat the demineralised feed water by means of hermitically sealed solar heater.

It is an object of invention to reduce the consumption of fossil fuel by supplying heat input from solar energy to preheat the demineralised feed water.

It is an object of invention to reduce the carbon or toxic emissions emitted by the combustion of fossil fuel to generate steam.

It is an object of invention to utilize the heat from renewable energy resource like solar energy rather than relying upon depleting non-renewable resource for instance fossil fuels like coal.

It is yet another object of invention to prevent the environment from excess of carbon emissions and also by dumping of the toxic waste in the land.

### STATEMENT OF THE INVENTION

The hermitically sealed solar water heater system for generation of electricity from thermal power plant comprising of:
(A) The overhead water tank (1) for supplying the demineralised water to the solar water heater by means of potential drop.
(B) The solar water heater (2) for preheating the feed water close to its boiling point by means of solar energy.
(C) The regulatory valve (3) for controlling the flow of water from overhead tank to hot water tank (5) in circumstances when there is no need of solar water heater.
(D) The siphon tube (4) for inducing the siphon action to drain the preheated demineralised water to the hot water tank (5).
(E) The hot water tank (5) for receiving the preheated demineralised water from solar water heater (2) and feed it to feed water heater (6).
(F) The feed water heater (6) to further increase the temperature of the preheated demineralised feed water by trapping the waste heat from exhaust gas.
(G) The feed water pump (7) for pumping the heated demineralised water from the feed water heater (6) to the boiler (8).
(H) The boiler (8) to convert the heated demineralised water to steam by means of heat generated from the combustion the fossil fuel such as coal.
(I) The turbine (9) driven by the steam generated by the boiler (8) to drive the generator (12).
(J) The condenser (10) to condense the steam coming out from the turbine (9) and converting to condensate water.
(K) The pump (11) for pumping the condensed water to the overhead water tank (1).
(L) The generator (12) coupled with the turbine (9) generates electricity by means of steam impinging on the blades of the turbine (9).
(M) The diaphragm (13) prevents the water from getting contaminated by sealing the tank hermitically.
(N) The bob cock (14) acting as a valve in the overhead water tank (1) regulating the level of water.

Conventionally Thermal power plant produces electricity from the steam generated by the vaporization of feed water by the heat from the combustion of fossil fuel in the boiler. The feed water is heated from its ambient temperature to vaporize it to steam thereby it consumes excess fossil fuel which emits toxic substance to the atmosphere thereby polluting the environment. The present invention by employing the hermitically sealed water tank by means of diaphragm prevents the feed water from getting contaminated before it is fed into the boiler. The solar water heater by hermitically sealing the overhead tank and utilizes the solar energy to increase the temperature of the feed water close to its boiling point before feeding it to the boiler which then requires very less heat input to generate the steam and thereby the consumption of fossil fuels and its emission are reduced. So, instead of relying upon the non-renewable energy resources for instance fossil fuel like coal, the present invention utilizes the renewable energy resources for instance solar energy for preheating thereby reducing the dependency on the fossil fuel due to which the emission of toxic substances is brought under control.

### Preheating:

In order to increase the thermal efficiency of the boiler, the fuel or the working fluid is often preheated before undergoing the process. In the case of boiler, the water which is the working fluid is heated by the heat generated by the combustion of fossil fuel and it is vaporized into steam which drives the turbine to generate electricity. But, converting the water from liquid phase to vapor phase consumes excess of heat input from fossil fuel which reduces the thermal efficiency of the boiler. Also the toxic substances which are emitted to the atmosphere is also a matter of concern for the future generation. So, the waste heat in the exhaust gas is trapped to increase the heat content of the working fluid before reaching the boiler and thereby the thermal efficiency is increased which is said to be the phenomenon of preheating.

### Thermal Expansion:

The solar water heater operates using the principle of thermal expansion and it is the tendency of matter to change in volume in response to a change in temperature. When a substance is heated, its particles begin moving and become active thus maintaining a greater average separation. The degree of expansion divided by the change in temperature is called the material's coefficient of thermal expansion and generally varies with temperature. In Solar Water heaters the medium of heat transfer is water which has good thermal expansion quality.

### Siphon Action:

Siphon is a continuous tube that allows liquid to drain from a reservoir through an intermediate point that is higher, or lower, than the reservoir, the flow being driven only by the difference in hydrostatic pressure without any need for pumping. It is necessary that the final end of the tube is lower than the liquid surface in the reservoir.

A typical siphon that carries a liquid over the top of an obstacle, works because gravity pulling down on the columns of liquid on each side, causes reduced hydrostatic pressure at the top of the two columns. Since the pressure at the top of the taller column is less than the pressure at the top of the shorter column, the liquid flows towards the taller column. The reduction of pressure caused by gravity pulling down the taller column of liquid is sufficient to suck liquid out of the upper reservoir and up the shorter column, much like liquid being sucked up a drinking straw. It is important to note however that the sucking of liquid over the top of the siphon is not like pulling the liquid. To say it is sucking is just another way of saying that the pressure is lowered at the top of the siphon and atmospheric pressure then pushes the liquid up the siphon.

A simplified conceptual model of a siphon is that it is like a chain hanging over a pulley with one end of the chain piled on a higher surface than the other. Since the length of chain on the shorter side is lighter than the length of chain on the taller side, gravity will pull the chain down towards the lower surface, and on the shorter side, the chain will be pulled up and over the pulley.

### Efficiency:

The efficiency of the boiler is the percentage of the total absorption heating value of the outlet steam in the total supply heating value. It is greatly dependent upon the consumption of fuel which gives the heat input to the feed water for vaporizing it. The thermal efficiency of boiler can be increased by preheating the feed water which reduces the fuel consumption thereby the heat supplied for the vaporization of feed water is reduced considerably. The present invention increase the efficiency of the boiler by preheating the feed water by means of solar energy.

An operation method of Hermitically Sealed Solar Water Heater system for generation of electricity from thermal power plant, said method comprising steps of:
(A) Supplying solar water heater (2) with demineralized cold water from the overhead water tank (1) by means of potential drop.
(B) Preventing the feed water from getting contaminated by sealing the overhead water tank (1) hermitically by means of diaphragm (13).
(C) Preheating the feed water by using the solar energy based water heater (2) and raising the temperature of the water close to its boiling point.
(D) Raising the hot water up in the siphon tube (4) and completely draining it into the hot water tank (5) by means of siphon action once it reaches the u-tube portion.
(E) Feeding the preheated demineralized water from the hot water tank (5) into the feed water heater (6). (F) Enabling preheated demineralized water to gain heat by trapping waste heat of exhaust gases from fossil fuels.
(G) Pumping the preheated demineralized water to the boiler (8) using the feed water pump (7) where it is vaporized into steam by the heat generated by the combustion of fossil fuel.
(H) Driving the turbine (9) blades using the vaporized steam which in turn drives the generator (12) to produce electricity.
(I) Pumping water generated by condensing steam using condenser (10) to the overhead water tank (1) by the pump (11) for the process to continue.

### BRIEF DESCRIPTION OF THE DRAWINGS

FIG. 1 illustrates the schematic representation of hermitically sealed solar water heater system for generation of electricity from thermal power plant.

FIG. 2 illustrates the steps involved in the operation method of hermitically sealed solar water heater system for generation of electricity from thermal power plant.

### DETAILED DESCRIPTION OF THE DRAWINGS

With global economy developing at rapid phase, the demand for electricity is increasing year by year. The consumption of electricity is far exceeding the production which raises the need to produce more power to sustain the demand. Power is generated from thermal power plant by combusting fossil fuels to vaporize the feed water by means of heat generated from the combustion of fossil fuel. But the combustion of fossil fuel emits toxic substances which is not friendly to the environment and the ecosystem. Also the fossil fuel which are at the depleted stage have to be conserved for a prolonged usage for the future generation. The fossil fuel can be conserved by utilizing the heat from the renewable energy resources along with the traditional method so that their consumption and harmful emissions can also be reduced.

The other and further features, advantages, and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and together with the description, serve to explain the principles of the invention in general terms. Like numerals refer to like parts throughout the disclosure. It was with knowledge of the foregoing state of the technology that the present invention has been conceived and is now reduced to practice.

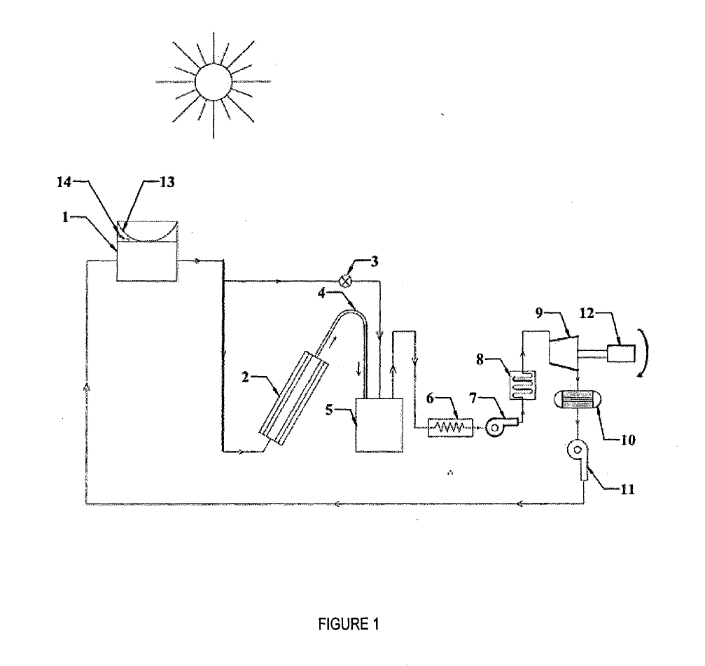

FIG. 1 illustrates the schematic representation of hermitically sealed solar water heater system for generation of electricity from thermal power plant. Demineralised water from the overhead water tank (1) reaches solar water heater (2) by means of potential drop. The level of the feed water in the overhead water tank (1) is regulated by bob cock (14) and diaphragm (13) prevents the feed water from getting contaminated by hermitically sealing the overhead water tank (1). The regulatory valve (3) regulates the flow of water to the hot water tank (5) in circumstances when there is no need of solar water heater (2). The solar water heater (2) increases the temperature of feed water from its ambient temperature close to its boiling point. The solar water heater (2) has tubing's for proper ventilation and for the inlet and outlet of cold and hot water respectively. The hot water outlet has siphon tubes (4) for draining the hot water to the hot water tank (5) which in turn is supplied to feed water heater (6).

The siphon tube (4) in the solar water heater (2) induces siphon effect through which the hot water is drained to hot water tank (5) and subsequently to the feed water heater (6). The siphon tube (4) is attached with its one end to the solar water heater (2) and the other with the feed water heater (6). The hot water in the solar water heater (2) is raised up in its level till it reaches the u-shaped portion of the siphon tube (4) and once it crosses the portion of u-shaped portion, siphon action is induced and thereby it drains the hot water from the solar water heater (2) completely to the feed water heater (6). The temperature of the feed water is brought close to the boiling point and thereby the feed water is preheated even before it reaches the feed water heater (6) by using solar energy based water heater (2).

The feed water in the feed water heater (6) passes through tubes which is heated by trapping the waste heat from the exhaust gas from the combustion of fossil fuel. So, the preheated demineralised feed water gains some more heat from the exhaust gas and its temperature is brought further close to the boiling point. The preheated demineralised feed water from the feed water heater (6) is pumped to the boiler (8) by means of feed water pump (7). The boiler (8) either may be of fire tube or water tube will combust the fossil fuel and the heat generated from the combustion of fuel will vaporize the heated demineralised feed water to steam which can be superheated or can be directly sent to the turbine (9).

A turbine (9) is a rotary engine that extracts energy from a fluid flow and converts it into useful work. The simplest turbines have one moving part, a rotor assembly, which is a shaft or drum with blades attached. Moving steam acts on the blades, or the blades react to the flow, so that they move and impart rotational energy to the rotor. The rotor drives the generator which is coupled to the turbine and thereby the power is generated. The steam while impinging on the blades of the turbine is expanded while it is still in the vapor phase with considerable amount of heat content which needs to be condensed and cooled for the operation to continue.

The condenser (10) used to condense steam from its gaseous to its liquid state, typically by cooling it. The condenser (10) comprises of tubes into which the steam passes and the coolant encloses the tubes. When the steam passes through the tubes, the latent heat is given up by the steam, and it will transfer the heat to the condenser coolant thereby the steam is condensed to liquid and also it loses away its heat to the coolant. The condensed water is then pumped to the overhead water tank (1) for uninterrupted generation of power.

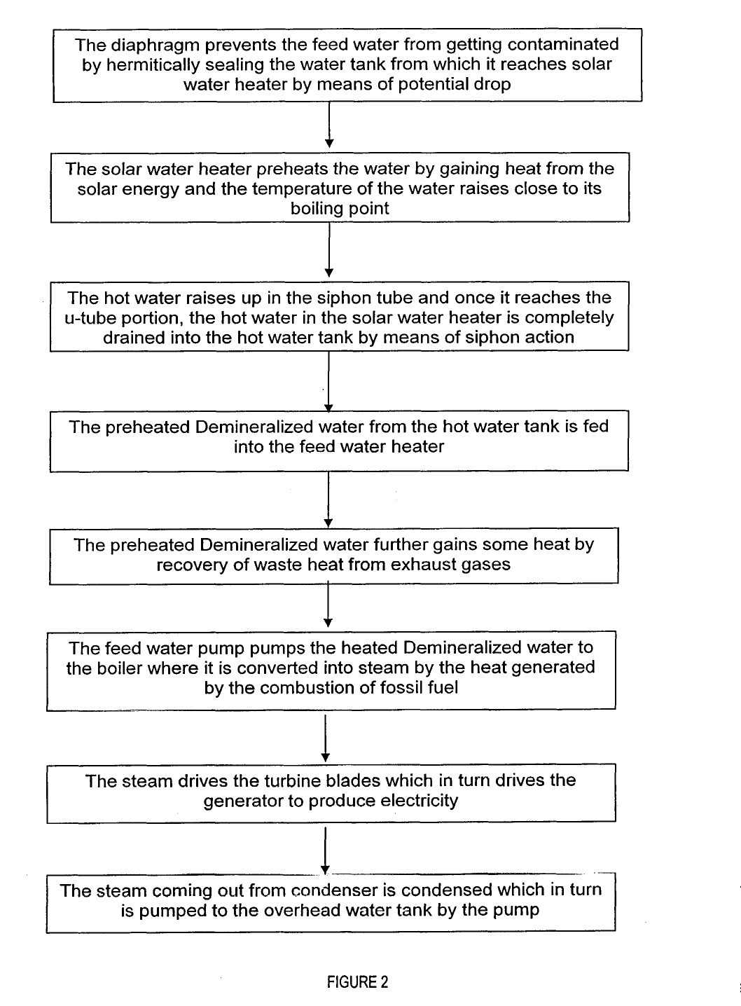

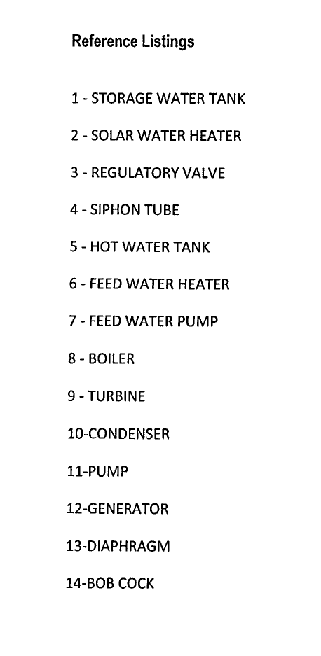

FIG. 2 illustrates the steps involved in the operation method of hermitically sealed solar water heater system for generation of electricity from thermal power plant.

An operation method of hermitically sealed solar water heater system for generation of electricity from thermal power plant, said method comprising steps of:
(A) Supplying solar water heater (2) with demineralized cold water from the overhead water tank (1) by means of potential drop.
(B) Preventing the feed water from getting contaminated by hermitically sealing the overhead water tank (1) by means of diaphragm (13).
(C) Preheating the feed water by using the solar energy based water heater (2) and raising the temperature of the water close to its boiling point.
(D) Raising the hot water up in the siphon tube (4) and completely draining it into the hot water tank (5) by means of siphon action once it reaches the u-tube portion.
(E) Feeding the preheated demineralized water from the hot water tank (5) into the feed water heater (6).
(F) Enabling preheated demineralized water to gain heat by trapping waste heat of exhaust gases from fossil fuels.
(G) Pumping the preheated demineralized water to the boiler (8) using the feed water pump (7) where it is vaporized into steam by the heat generated by the combustion of fossil fuel.
(H) Driving the turbine (9) blades using the vaporized steam which in turn drives the generator (12) to produce electricity.
(I) Pumping water generated by condensing steam using condenser (10) to the overhead water tank (1) by the pump (11) for the process to continue.

The generation of electricity from the thermal plant by supplying preheated demineralised water from solar water heater is as follows:

Conventionally, power is generated from the thermal power plant by the steam formed by vaporizing the feed water by means of heat from the combustion of fossil fuel. But the combustion of fossil fuel such as coal emits toxic substances and dumping the ash also raises environmental concerns. Also, the fossil fuels which are the depleting stage needs to be conserved. So, the present invention overcomes this issues by utilizing solar energy along with the traditional fossil fuel based process. The feed water at the overhead water tank (1) is hermitically sealed by means of diaphragm (13). The demineralised water from the overhead water tank (1) reaches solar water heater (2) by means of potential drop. The feed water in the solar water heater (2) then gains heat from the solar energy and its temperature increases from the ambient temperature close to its boiling point. The hot water being lower in density than cold water raises up in the solar water heater. The raising hot water raises its level till it reaches the u-shaped portion of the siphon tube (4) and once it crosses the u-shaped portion, siphon action is induced and thereby the hot water from the solar water heater (2) is drained completely to the hot water tank (5) which in turn reaches feed water heater (6) and thereby the feed water had attained some heat before it reaches the thermal unit. The feed water heater (6) traps the waste heat from the exhaust gas and the heated demineralised feed water is further heated by means of conduction with the waste heat of the exhaust gases. The heated demineralised feed water is pumped to the boiler (8) by means of feed water pump (7). The boiler (8) consists of heating chamber in which the fossil fuel is combusted and by means of conduction principles the heated demineralised feed water is vaporized to steam which is then directed to the turbine (9). The steam impinging on the turbine (9) blades drives it and the generator (12) which is coupled with the turbine (9) generates power. The steam coming out of turbine (9) is condensed to water by means of condenser (10) having tubes enclosed by condensate liquid which condense the vapor and also absorbs heat from the steam by means of conduction. The condensed water is pumped to the overhead water tank (1) by means of pump (11) and the process is operated and thereby the power is generated continuously.

It will be obvious to a person skilled in the art that with the advance of technology, the basic idea of the invention can be implemented in a plurality of ways. The invention and its embodiments are thus not restricted to the above examples but may vary within the scope of the claims.

Further the above-described embodiments of the present invention are intended to be examples only. Alterations, modifications and variations may be effected to the particular embodiments by those of skill in the art without departing from the scope of the invention, which is defined solely by the claims appended hereto.

1. The hermitically sealed solar water heater system for generation of electricity from thermal power plant comprising of:
(A) The overhead water tank for supplying the demineralised water to the solar heater by means of potential drop,
(B) The solar water heater for preheating the water close to its boiling point by means of solar energy
(C) The regulatory valve for controlling the flow of water from overhead tank to hot water tank in circumstances when there is no need of solar water heater,
(D) The siphon tube for inducing the siphon action to drain the preheated demineralised water to the hot water tank,
(E) The hot water tank for receiving the preheated demineralised water from solar water heater and feed it to feed water heater,
(F) The feed water heater to further increase the temperature of the preheated demineralised feed water by utilizing the heat from exhaust gas,
(G) The feed water pump for pumping the demineralised water from the fed water heater to the boiler,
(H) The boiler to convert the heated demineralised water to steam by means of heat generated from the combustion the fossil fuel such as coal,
(I) The turbine driven by the steam generated by the boiler to drive the generator,
(J) The condenser to condense the steam coming out from the turbine to water,
(K) The pump for pumping the condensed water to the overhead tank,
(L) The generator coupled with the turbine generates electricity by means of steam impinging on the blades of the turbine,
(M) The diaphragm prevents the water from getting contaminated,
(N) The bob cock acting as a valve in the overhead water tank regulating the level of water.

2. The system as claimed in claim 1 wherein the diaphragm prevents the feed water from being contaminated by hermitically sealing the overhead water tank.

3. The system as claimed in claim 1 wherein the demoralised feed water reaches solar water heater by means of potential drop.

4. The system as claimed in claim 1 wherein the solar energy based water heater raises the temperature of feed water close to its boiling point.

5. The system as claimed in claim 1 wherein the siphon tube induces siphon action to drain the hot water from the solar water heater to the feed water heater.

6. The system as claimed in claim 1 wherein the regulatory valve regulates the flow of water to the hot water tank in circumstances when there is no need of solar water heater.

7. The system as claimed in claim 1 wherein the hot water tank transfers hot water to feed water heater of thermal unit through siphon action by means of siphon tube.

8. system as claimed in claim 1 wherein the feed water heater traps the waste heat from the exhaust gas and utilize it for heating the preheated demineralised feed water.

9. The system as claimed in claim 1 wherein the heated demineralised feed water is pumped to the boiler by means of feed water pump.

10. The system as claimed in claim 1 wherein the boiler vaporize the heated demineralised feed water to generate electricity by means of turbine.

11. An operation method of hermitically sealed solar water heater system for generation of electricity from the thermal power plant, said method comprising steps of:
(A) Supplying solar water heater with demineralized cold water from the overhead water tank by means of potential drop,
(B) Preventing the feed water from getting contaminated by hermitically sealing the overhead water tank by means of diaphragm,
(C) Preheating the feed water by using the solar energy based water heater and raising the temperature of the water close to its boiling point,
(D) Raising the hot water in the siphon tube and completely draining it into the hot water tank by means of siphon action once it reaches the u-tube portion,
(E) Feeding the preheated demineralized water from the hot water tank into the feed water heater,
(F) Enabling preheated demineralized water to gain heat by recovery of waste heat from exhaust gases,
(G) Pumping the preheated demineralized water to the boiler using the feed water pump where it is converted into steam by the heat generated by the combustion of fossil fuel,
(H) Driving the turbine blades using the vaporized steam which in turn drives the generator to produce electricity,
(I) Pumping water generated by condensing steam using condenser to the overhead water tank by the pump.

12. (canceled)
